(19) United States
(12) Patent Application Publication
(10) Pub. No.: US 2026/0201714 A1
(43) Pub. Date: Jul. 16, 2026

(54) SYSTEM AND METHOD FOR REPAIRING A DOOR THRESHOLD USING A THRESHOLD COVER

(71) Applicant: Gregory D. Bradford, Issaquah, WA (US)

(72) Inventor: Gregory D. Bradford, Issaquah, WA (US)

(21) Appl. No.: 19/015,662

(22) Filed: Jan. 10, 2025

(51) Int. Cl. E04G 23/02; E06B 1/70

(52) U.S. Cl. CPC E04G 23/02; E06B 1/70

(57) ABSTRACT

A threshold cover and a method of installation over an existing door threshold are provided. The method includes adjusting the size of the threshold cover to match the size of the existing door threshold, notching side jambs of the door to form side notched openings to allow the threshold cover to slide into the notched openings. The method includes temporarily removing the threshold cover from the notched openings, applying adhesive at a rear side of the threshold cover, reinserting the threshold cover into the notched openings, tapping over the threshold cover to strengthen the bond between the cover and the existing threshold, cleaning excess adhesive left over the threshold cover and caulking the seam of the door threshold covered with the threshold cover for a finished look, allowing the adhesive to dry, and optionally attaching the threshold cover on top of the existing threshold using the screws.

### FIELD OF THE INVENTION

The present invention relates to the field of repairing door thresholds, and more particularly, the present invention relates to a repair threshold cover, a system, and a method of installation of the repair threshold over a damaged door threshold.

### BACKGROUND

A door threshold is an essential component of a home's design, providing a decorative and functional transition at the bottom of exterior or interior door frames. Over time, door thresholds can wear down due to damage during construction, constant foot traffic and weather exposure, leading to safety and aesthetic concerns. Damage to the threshold adversely affects the door seal and operability of sliding or hinged doors. Thresholds may be installed for both hinged doors and sliding doors.

During the construction of a building, the doorways, doors, and thresholds are installed relatively early in the construction process to protect the interior from the elements and prevent unauthorized access, theft, and vandalism. However, during the construction process, there is a large amount of traffic that flows across the door thresholds. The traffic may inadvertently dent, transport contaminants, such as dirt and abrasives adhered to worker shoes and construction equipment which eventually lodges the thresholds. Many of the thresholds are expensive and include finished surfaces applied during manufacturing (e.g., extruded finishes) which are difficult to repair if they are damaged.

Threshold repair due to damage during construction is a common and expensive job that contractors face. Similarly, if modifications to a building are made or heavy articles are to be rolled over the existing home threshold then during moving, the threshold may require protection from the through traffic.

Usually, damaged thresholds require complete removal of the exterior door, trims, and jambs to replace the damaged threshold with a new one. It is extremely labor intensive as it requires using highly skilled carpenters and painters. The materials usually needed to replace a damaged threshold are a new threshold, interior and exterior trims, caulking, putty, and paint for interior and exterior trims. It is not a simple matter to replace a threshold, because the threshold extends under and is fastened to the bottom ends of the vertical jambs and any sidelight casement jambs. To do a proper replacement, one requires removing materials surrounding the assembly, such as brick, siding, trim drywall, and caulk, then removing the door and dismantling the frame and so on, which are costly and require a lot of time and effort.

Various kinds of retrofit thresholds, and protective covers usable with existing door thresholds for an entry door are already known in the art. For instance, U.S. Pat. No. 2,840,868 discloses an improved threshold made up of readily separable parts but which nevertheless have a unitary and homogeneous appearance when said parts are assembled together. The threshold disclosed in the US patent '868 includes a section adapted to overlie a door check in which the complete threshold may be assembled in a unitary structure before being placed in the doorway. U.S. Pat. No. 6,269,591 discloses a threshold protective cover that includes removable sections for installation over varying threshold widths. Assigned to the same inventor U.S. Pat. No. 6,216,395 discloses a one-piece cover that is temporarily attached to the door threshold. U.S. Pat. Nos. 25,590 and 4,055,917 are both of interest in that they disclose threshold assemblies that are molded or extruded and include a front lip. Although, the solutions presented in U.S. Pat. Nos. 2,840,868, 6,269,591, 6,216,395, 25,590 and 4,055,917 serve the purpose to some extent, none of the solutions are easy to use solutions as they are either complicated, time-consuming and expensive solutions and mostly cannot be used with existing entry exterior doors and some are believed to leak in storm-driven rain conditions.

It would be beneficial to homeowners to be able to repair the appearance and functionality of the underlying thresholds without having to disturb bricks, siding, trim, door frame, drywall, caulk, paint, etc., or purchase a new threshold.

### SUMMARY

An object of the present invention is to provide a protective threshold cover adapted to protect and repair a threshold of a door.

An object of the invention is to enable one to repair a damaged threshold without having to dismantle the door frame, trims, jambs, etc, or remove the existing threshold.

One object of this invention is to provide a repair or protective threshold cover that protects the existing door threshold while permitting the closure of the door.

One object of this invention is to provide a protective threshold cover that is adaptable to protect a wide variety of threshold configurations.

Another object of this invention is to provide a protective threshold cover that is economical to manufacture, and easy to install and use.

Another object of the present invention is to provide a one-piece protective threshold cover that will not rot, rust, corrode, or otherwise deteriorate with use easily and due to extreme weather conditions.

While the way that the present disclosure addresses the disadvantages of the prior art will be discussed in greater detail below, in general, the present disclosure provides a method of installation of a threshold cover over an existing door threshold. The method includes measuring the size of the existing door threshold, adjusting the size of the threshold cover length-wise and/or width-wise to match the size of the existing door threshold, notching two side jambs of a door of the existing door threshold to a certain distance above the existing door threshold, and allowing the threshold cover to slide into two side notched openings made on the two side jambs.

In an embodiment, the notched openings are made such that the threshold cover snugly fits on top of the existing door threshold.

In an embodiment, the two side jambs are notched 1/16″ to ⅛″ above the existing threshold forming the two side notched openings to allow the threshold cover to slide over smoothly.

In an embodiment, the method of installation of a threshold cover over an existing door threshold comprises temporarily removing the threshold cover from the notched openings, applying an adhesive at a rear side of the threshold cover, reinserting the threshold cover into the notched openings made on the two side jambs to cover the top of the existing threshold, tapping over the threshold cover to properly fit and strengthen the bond between the threshold cover and the top surface of the existing threshold, and cleaning any excess construction adhesive.

In an embodiment, the method of installation of the threshold cover over the existing door threshold further comprises caulking the seam of the door threshold covered with the threshold cover for a finished look, allowing the adhesive to dry, and fastening screws (eg. pan head screws or flat head screws) into a set of predrilled holes drilled on the threshold cover by an installer of the threshold cover to further strengthen the attachment of the threshold cover on top of the existing threshold.

The present disclosure discloses a threshold cover according to another aspect of the present invention. The threshold cover includes a substantially flat horizontal portion with a top non-skid surface, a bottom surface, a front edge, and a rear edge; and
a vertical portion extending downward from the front edge of the flat horizontal portion and comprising a height sufficient to cover a front edge of an existing threshold.

In an embodiment, the flat horizontal portion comprises a plurality of ridges extending along the length of the flat horizontal portion to provide the top non-skid surface.

In an embodiment, the vertical portion is oriented substantially perpendicular or at a predefined angle to the flat horizontal portion.

In an embodiment, the vertical portion is curved outward to the flat horizontal portion.

In an embodiment, the curved vertical portion forms a longitudinally extending space with the front edge of the flat horizontal portion.

In an embodiment, the bottom surface is substantially flat to provide surface-to-surface contact with the existing threshold.

The present disclosure further discloses a system for repairing an existing door threshold according to another aspect. The system for repairing an existing door threshold includes a cutting tool to cut a threshold cover to match a measured length and width of the existing door threshold and a multitool for notching two side jambs of a door to form two side notched openings to allow the threshold cover to slide over smoothly. The system for repairing an existing door threshold includes a rubber mallet for tapping and inserting the threshold cover into the two side notched openings.

In an embodiment, the threshold cover includes a substantially flat horizontal portion with a top non-skid surface, a bottom surface, a front edge, and a rear edge; and a vertical portion extending downward from the front edge of the flat horizontal portion and comprising a height sufficient to cover a front edge of an existing threshold.

In an embodiment, the cutting tool comprises a metal cutting circular saw.

In an embodiment, the flat horizontal portion includes a plurality of ridges extending along the length of the flat horizontal portion to provide the top non-skid surface.

In an embodiment, the vertical portion is oriented substantially perpendicular or at a predefined angle to the flat horizontal portion.

In an embodiment, the vertical portion is curved outward to the flat horizontal portion.

In an embodiment, the two side jambs are notched 1/16″ to ⅛″ above the existing threshold forming the two side notched openings to allow the threshold cover to slide over smoothly.

In another embodiment, it is possible to install the threshold cover without notching two side jambs rather by notching the threshold around the two side door jambs and applying more glue and/or adding screws (eg. pan head screws or flat head screws) for attaching it to the existing threshold.

These and other features and advantages of the present invention will become apparent from the detailed description below, in light of the accompanying drawings.

### BRIEF DESCRIPTION OF THE DRAWINGS

A more complete understanding of the present disclosure may be derived by referring to the detailed description and claims when considered in connection with the figures, wherein like reference numerals refer to similar elements throughout the figures, and

FIG. 1 illustrates a top perspective view of a protective threshold cover of the present invention, according to an embodiment.

FIG. 2 illustrates a bottom perspective view of a protective threshold cover of FIG. 1.

FIG. 3 illustrates a side perspective view of a protective threshold cover of FIG. 1.

FIG. 4 illustrates an isometric view of a protective threshold cover according to another embodiment as applied on top of the underlying threshold.

FIG. 5A illustrates a side view of the protective threshold cover shown in use in FIG. 4.

FIG. 5B illustrates a front view of the protective threshold cover shown in use in FIG. 4.

FIG. 5C illustrates a top view of the protective threshold cover shown in use in FIG. 4.

FIG. 6 illustrates a typical top-plan view of the underlying threshold with the protective threshold cover of FIG. 4 applied over the underlying threshold, wherein wall and jamb sections of a door are shown for reference purpose.

FIG. 7 shows a cutout section along AA of FIG. 6.

FIG. 8 shows the threshold cover of the present invention installed over the existing door threshold of an exterior door, the exterior door is shown partially with the door in an opened state.

FIG. 9 shows a sectional view of the threshold cover installed over the existing door threshold with the threshold cover sliding into the two-side opening made on the two-side jambs of the exterior door.

FIG. 10 illustrates a flowchart representing a method of installation of a threshold cover over an existing door threshold.

FIGS. 11 and 12 show a cutout section similar to FIG. 7 to demonstrate alternative ways that can be adopted for notching the threshold cover over notching the two side jambs, according to various embodiments.

### DETAILED DESCRIPTION

The following description is of exemplary embodiments of the invention only and is not intended to limit the scope, applicability, or configuration of the invention. Rather, the following description is intended to provide a convenient illustration for implementing various embodiments of the invention. As will become apparent, various changes may be made in the function and arrangement of the elements described in these embodiments without departing from the scope of the invention as set forth herein. It should be appreciated that the description herein may be adapted to be employed with alternatively configured devices having different shapes, components, attachment mechanisms and the like and still fall within the scope of the present invention. Thus, the detailed description herein is presented for purposes of illustration only and not for limitation.

Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

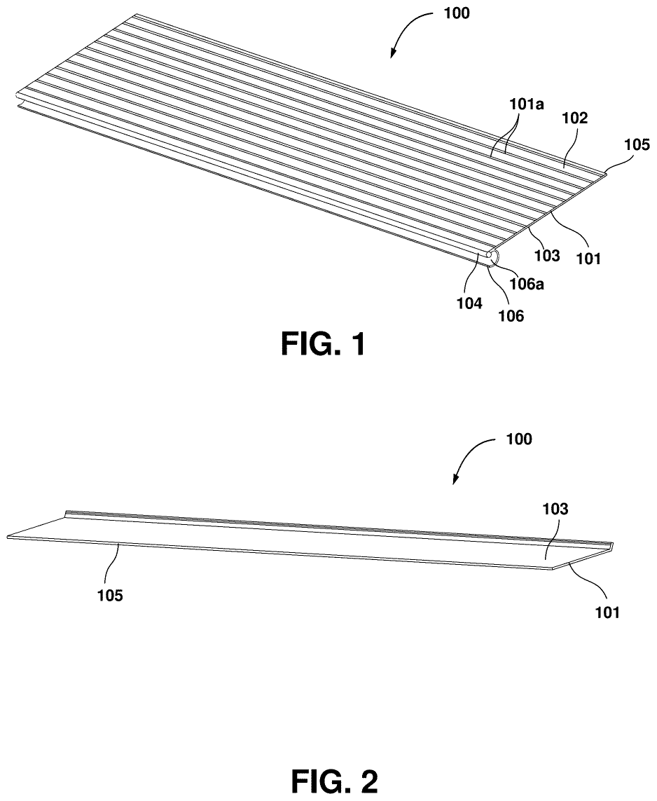

A replacement/repair or a protective threshold cover, a system, and a method for quickly repairing a damaged door threshold will now be described with reference to accompanying drawings, particularly FIGS. 1-12.

Referring to FIGS. 1-3, there is provided a repair or a protective threshold cover 100 according to an embodiment. The repair or threshold cover 100 embodying the invention is formed using a L-shaped piece of material, preferably an inexpensive non-corroding metal, such as aluminum. However, it should be understood that the threshold cover 100 may be made using any other suitable material.

The threshold cover 100 includes a substantially flat horizontal portion 101 with a top non-skid surface 102, a bottom surface 103, a front edge 104, and a rear edge 105. The flat horizontal portion 101 is preferably like a flat metallic plate. The substantially flat horizontal portion 101 comprises a plurality of ridges 101a formed on the horizontal portion 101 that extends along the length of the flat horizontal portion 101 to provide the top non-skid surface. The substantially flat horizontal portion 101 may include other patterns instead of parallelly extending ridges 101a along its length. The bottom surface 103 of the threshold cover 100 is substantially flat to provide surface-to-surface contact with the existing threshold 108 when placed on top of the existing threshold 108. In an embodiment, the flat horizontal portion 101 of the threshold cover 100 is not drilled with any holes.

In an embodiment, the holes 101b may be drilled on the flat horizontal portion 101 during the process of installation of the threshold cover 100 by an installer so that suitable screws (not seen) may be passed and fastened attaching the threshold cover 100 over the existing threshold 108. The screws that may be suitable for use include but are not limited to pan head screws and flat head screws.

Pan head screws Installation steps:
With the threshold cover 100 placed over the existing threshold 108, find the center of the threshold in the door opening.
Use a 3/32″ bit to drill a pilot hole for a #4 pan head metal screw.
Use a hand screwdriver, and install the #4×⅜″ screw. Overtightening is not recommended. A power screw gun is not recommended as it may strip out the metal and the threads will not hold.
Larger screws may be used at the installer's option. Nothing longer than ½″ to prevent the screws from bottoming out.

Flat Head Screws Installation steps:
With the threshold cover 100 placed over the existing threshold 108, find the center of the threshold in the door opening.
Using a 3/32″ bit drill a pilot hole for a #4 flat head metal screw.
Using a 7/32″ bit, drill on top of the previously drilled pilot hole very gently allowing enough penetration to flush out the top of the screw head to the top of the threshold cover. It is recommended not to over penetrate or screw will not attach to the existing threshold 106 underneath.
Using a hand screwdriver, install the #4×⅜″ screw. Overtightening is not recommended. A power screw gun is not recommended as it may strip out the metal and the threads will not hold.

Larger Screws are not recommended when using the flat head screw installation option. Nothing longer than ½″ to prevent the screw from bottoming out.

Additional optional screws may be added along the threshold cover 100 at the installer's desired spacing. Approximately 12″ spacing is recommended.

In some other embodiment, the flat horizontal portion 101 of the threshold cover 100 may be provided with predrilled holes 101b for using screws on the threshold cover 100 to attach the threshold cover 100 on top of the existing threshold 108 besides making use of adhesive to attach the threshold cover 100 on top of the existing threshold 108.

The flat horizontal portion 101 may have a suitable thickness complementing the thickness of the existing threshold 108 to ensure the threshold cover 100 is durable at the same time does not add much thickness to the existing threshold. The flat horizontal portion 101 may be customized or made in length and width based on the size and make of the exiting door thresholds 108.

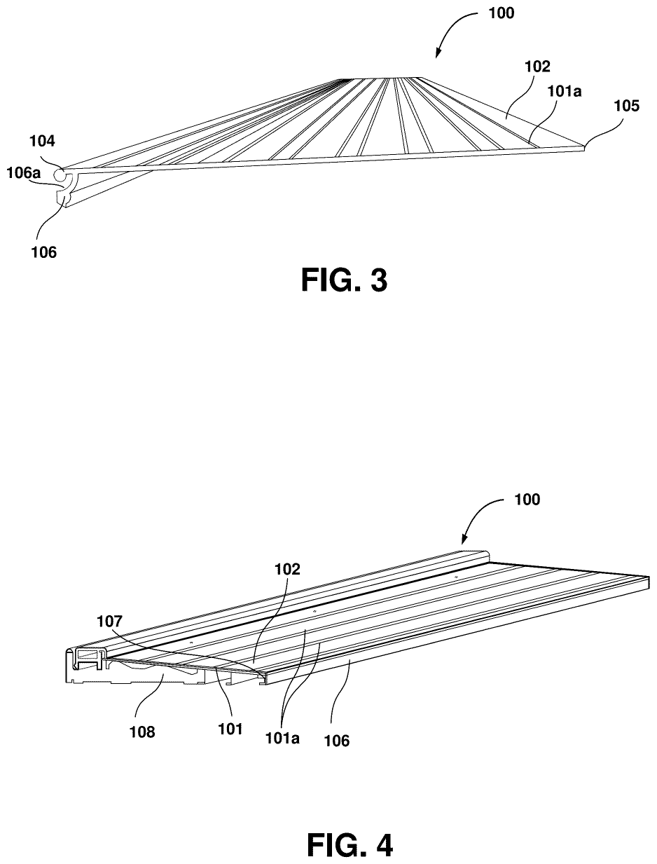

The threshold cover 100 further includes a vertical portion 106 extending downward from the front edge 104 of the flat horizontal portion 101. The threshold cover 100 includes a height sufficient to cover a front edge 107 of an existing threshold 108 as seen in FIG. 4. The vertical portion 106 is oriented substantially perpendicular or oriented at a predefined angle to the flat horizontal portion 101 according to one embodiment as preferably seen in FIGS. 4, 5A-5C, 6-7. In another embodiment, the vertical portion 106 is curved outward with respect to the flat horizontal portion 101 as best seen in FIG. 3. The vertical portion 106 extending from the front edge 104 may have other suitable shapes. As seen in FIG. 1 and FIG. 3, the curved vertical portion 106 forms a longitudinally extending space 106a with the front edge 104 of the flat horizontal portion 101.

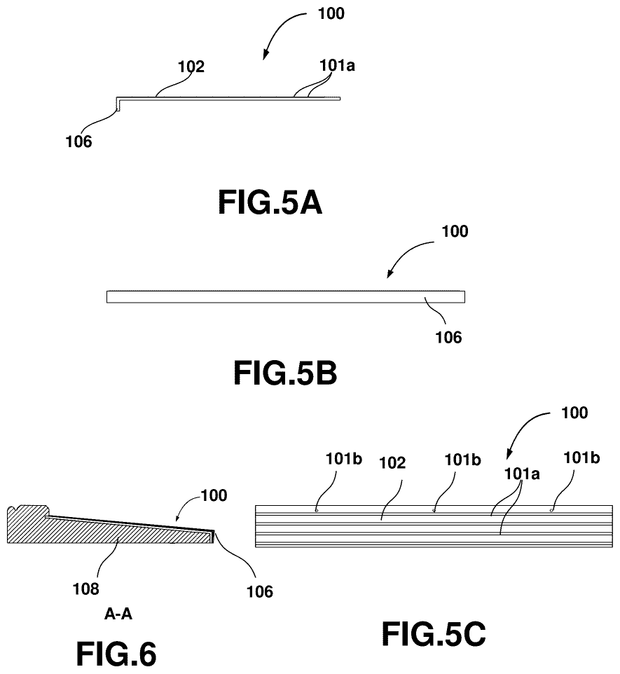

FIG. 4 illustrates an isometric view of a repair or protective threshold cover according to another embodiment as applied on top of the underlying threshold. In this embodiment, the vertical portion 106 is seen oriented substantially perpendicular to the flat horizontal portion 101. FIGS. 5A-5C shows a side view, a front view, and a top view of the protective threshold cover in use in FIGS. 4 and 6. FIG. 6 illustrates a typical top-plan view of the underlying threshold 108 with the protective threshold cover of FIG. 4 applied over the underlying threshold 108, wherein wall and jamb sections of a door are shown for reference purposes.

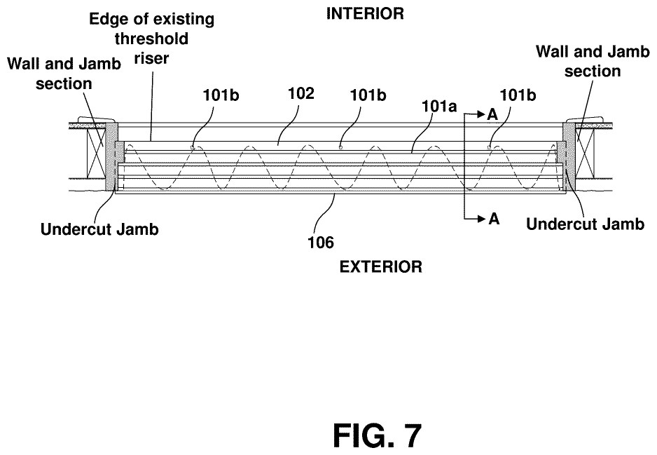

FIG. 7 shows a typical plan view of the threshold installed over an existing threshold. FIG. 7 shows the undercut/notched jamb that allows the threshold cover to slide inside. The wall section and jambs are shown only for reference purposes. FIG. 7 also shows the cover with drilled holes 101b that may be drilled during the process of installation. FIG. 7 shows the construction adhesive applied in a serpentine pattern at the rear side 103 of the cover 100.

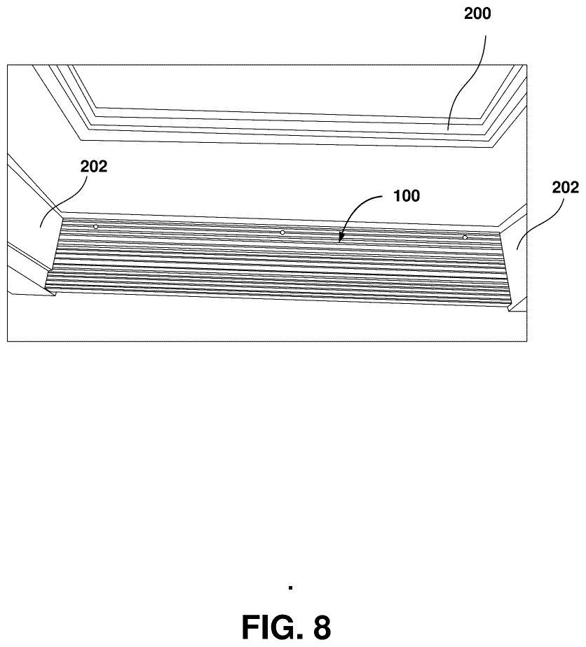

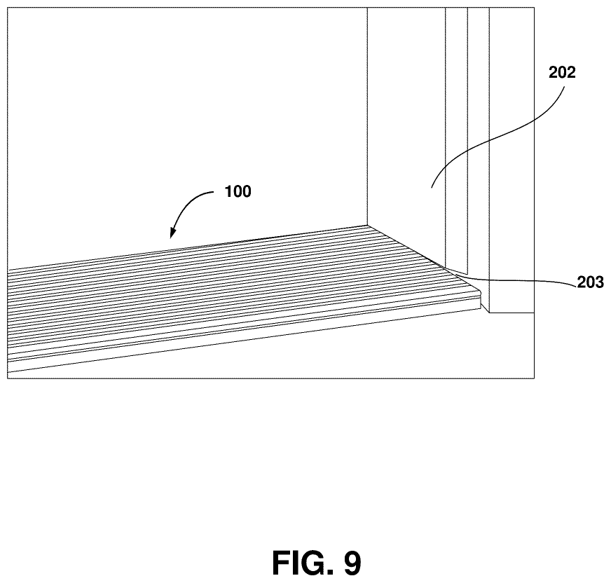

FIG. 8 shows the threshold cover of the present invention installed over the existing door threshold of an exterior door, and wherein the exterior door is shown partially with the door in an opened state. FIG. 9 shows a sectional view of the threshold cover installed over the existing door threshold with the threshold cover sliding into the two-side opening made on the two-side jambs of the exterior door.

The threshold cover 100 is quickly installable on an existing damaged threshold 108 for a repair instead of opting for replacement of the existing threshold that requires involving a carpenter, painter, and even sometimes civil contractor and involves a lot of cost and time. Specifically, utilizing the proposed threshold cover 100, one does not need to disturb existing bricks, siding, trim, door frame, drywall, caulk, paint, etc., or purchase a new threshold. One can simply carry out simple steps to quickly repair existing threshold 108.

Referring to FIGS. 6-9 and FIG. 10 specifically, the process of installation begins with step 802 which describes ensuring correct sizing of threshold cover 100 before fitting it over an existing door threshold 108. It is of utmost importance that the threshold cover 100 is placed flush against the existing threshold 108. The user or installer may remove nails or other objects protruding upward from the original threshold 108 first, so that good surface-to-surface contact results. This step of properly sizing the threshold cover 100 begins with measuring the length of the existing threshold 108 located at the bottom of a door 200. One can use a metal cutting circular saw or similar cutting tool to cut or adjust the threshold cover 100 to match the measured length of the existing threshold 108. Additionally, if the threshold cover 100 is too wide to fit snugly against the threshold cap rise and front edge 107 of the existing threshold 108, the user or installer may require an additional cut along the back edge of the threshold cover 100 to further adjust the sizing widthwise and ensure a tight fit of the threshold cover 100 over the existing threshold 108. One can use other supporting tools such as clamping tools to clamp down the threshold cover 100 on a table or other surfaces to aid in the process of cutting down the threshold cover 100 lengthwise or widthwise.

Next step 804 describes about notching or cutting two side jambs 202 of a door 200 (FIGS. 8-9) of the existing door threshold 108 (not seen) to a certain distance above the existing door threshold 108. In an embodiment, the side jambs may be notched 1/16″ to ⅛″ above the existing threshold 108 forming two side notched openings 203. Although FIG. 9 shows only one notched opening 203 on one of the jambs, it should be understood that both side jambs 202 include the notched opening 203 to slidably receive the cover 100. A multi-tool may be used for cutting or notching the side jambs. After forming the notched openings 203 on either side jambs 202, the user or installer is required to verify the threshold cover 100 slides into the notched openings 203 under the bottom of the side jambs 202 and properly fit over the existing threshold 108. The process of verifying the proper sliding of the cover 100 into the openings 203 is to make sure the cover 100 snugly fits against the existing threshold riser.

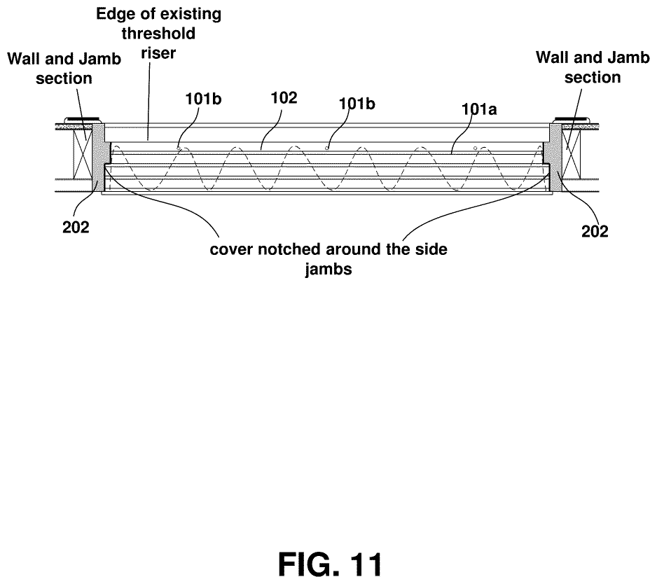

In another embodiment, as an alternative to notching the jambs (as described in step 804), the cover 100 itself may be notched around the side jambs 202 as seen in FIG. 11. In other words, the cover 100 would be cut to fit around the jambs and installed in the vertical direction.

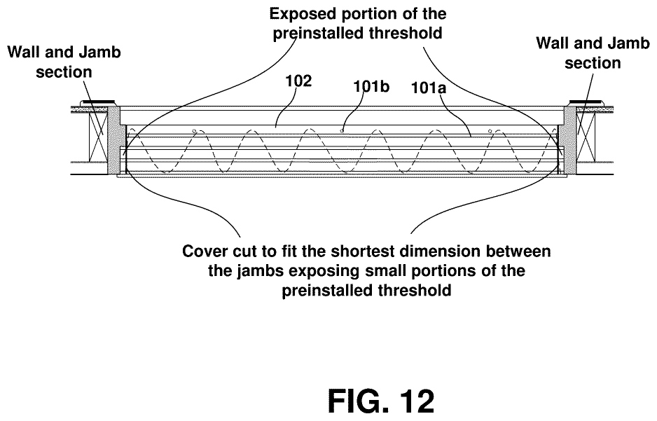

In another embodiment, as another alternative to notching the side jambs (as described in step 804), one can simply cut the cover 100 to fit between the shortest dimension between the jambs 202 as seen in FIG. 12, thereby exposing small portions of the preinstalled threshold 108.

Next step 806 describes allowing the threshold cover 100 to slide into two side notched openings 203 made on the two side jambs 202 (this step may not be necessary if the side jambs 202 aren't notched as per step 804).

Next step 808 describes temporarily removing the threshold cover 100 from the notched preferably for applying an adhesive at the rear side 103 of the threshold cover 100 (Step 810). The adhesive used is preferably a construction adhesive known in the art. In an embodiment, the adhesive may be applied in a serpentine pattern on the rear side 103 of the threshold cover 100 (as seen in FIG. 7). The adhesive may be used in any other patterns. In another embodiment, instead of applying adhesive, a double-sided adhesive tape such as VHB tape may be used to secure the cover 100 to the underlying threshold 108.

Next step 812 describes about reinserting the threshold cover 100 back into the notched openings 203 after applying the adhesive (or double-sided adhesive tape) at the rear side 103 of the cover 100. While reinserting one can insert the cover 100 in place by tapping with a rubber mallet or similar tool. Next step 814 describes tapping over the threshold cover 100 to properly fit and strengthen the bond between the threshold cover 100 and the top surface of the existing threshold 108. There may be further an optional step involved that relates to cleaning any excess construction adhesive. One can use, for example, acetone, solvent, or paint thinner to clean up any excess construction adhesive thoroughly

Next step 816 describes caulking the seam of the door threshold covered with the threshold cover 100 for a finished look. The caulking is done using waterproof filler or sealant. At step 818, the adhesive is allowed to dry for a predefined period of time say for 24 hours. Further, the method involves optionally fastening a set of screws (pan head screws or flat head screws) into a set of holes 101b drilled on the threshold cover by an installer while installing the threshold cover according to an embodiment step 820. The steps of installation of screws are described above and are thus omitted from here. In some other embodiment, the screws may not be used and just the use of adhesive may be sufficient to form the bond needed between the cover 100 and the existing threshold 108.

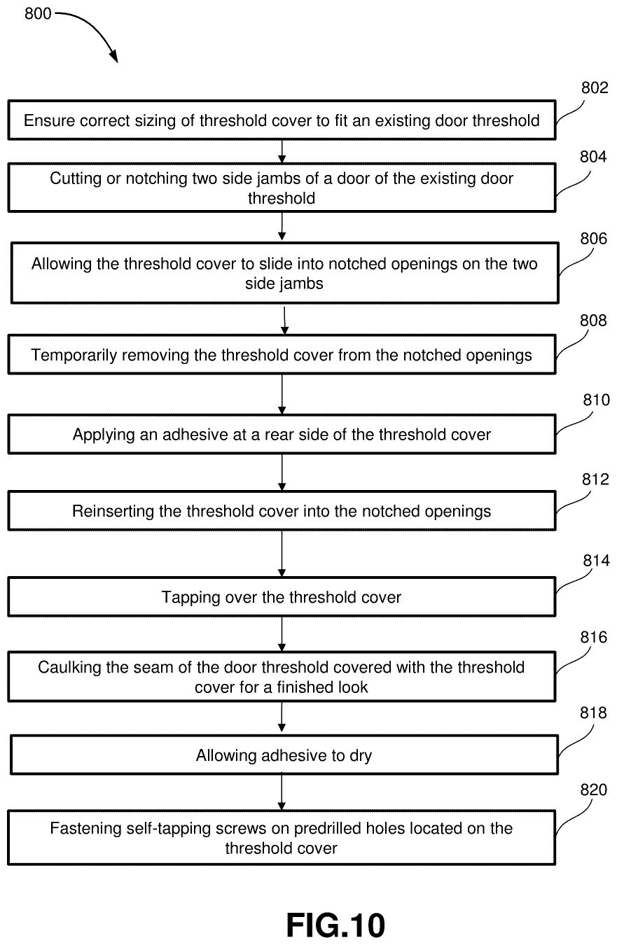

Although the method of installation of the threshold cover 100 as described with respect to FIG. 10 requires cutting or notching of two side jambs, it should be understood that the invention is implementable without even notching or cutting and preparing the notched openings 203 and instead just cutting the length of the cover 100 from both sides to fit between the two side jambs 202 located on the sides of the door 200.

The proposed threshold cover 100 is made of metal to cover up a damaged existing threshold. Although the threshold cover 100 may be made in different lengths and widths. It is to be noted that most exterior doors are 24″-144″ wide and sometimes combination of doors can make the exterior door even wider. The threshold cover can be cut or pieced together to fit different widths of doors. Existing door thresholds are for 2×4-12″ walls so the required depth of the threshold cover could range from 4-12″. Further, this disclosure describes use of specific cutting tool, and multi tool, it should be understood there may be other tools that might be necessary which are not included for example, eye glasses, gloves and so on for the safety of the installer.

Finally, while the present invention has been described above with reference to various exemplary embodiments, many changes, combinations, and modifications may be made to the exemplary embodiments without departing from the scope of the present invention. For example, the various components may be implemented in alternative ways. These alternatives can be suitably selected depending upon the particular application or in consideration of any number of factors associated with the operation of the device. In addition, the techniques described herein may be extended or modified for use with other types of devices. These and other changes or modifications are intended to be included within the scope of the present invention.

1. A method (800) of installation of a threshold cover (100) over an existing door threshold (108), comprising:
measuring the size of the existing door threshold (108);
adjusting the size of the threshold cover (100) length-wise and/or width-wise to match the size of the existing door threshold (108);
notching at least two side jambs (202) of a door (200) of the existing door threshold (108) to a certain distance above the existing door threshold (108), or the threshold cover (100) around the two side jambs (202); and
allowing the threshold cover (100) to at least slide into two side notched openings (203) made on the two side jambs (202), or snugly fit on top of the existing door threshold (108).

2. The method (800) of claim 1, wherein the notched openings (203) are made such that the threshold cover (100) snugly fits on top of the existing door threshold (108).

3. The method (800) of claim 1, wherein the two side jambs (202) are notched 1/16″ to ⅛″ above the existing threshold (108) forming the two side notched openings (203) to allow the threshold cover (100) to slide over smoothly.

4. The method (800) of claim 1 further comprising steps:
temporarily removing the threshold cover (100) from the notched openings (203);
applying an adhesive at a rear side of the threshold cover (100);
reinserting the threshold cover (100) into the notched openings (203) made on the two side jambs (202) to cover the top of the existing threshold (108);
tapping over the threshold cover (100) to properly fit and strengthen the bond between the threshold cover (100) and the top surface of the existing threshold (108); and
cleaning any excess construction adhesive.

5. The method of claim 4 further comprising steps:
caulking the seam of the door threshold covered with the threshold cover (100) for a finished look;
allowing the adhesive to dry; and
fastening screws into a set of holes drilled on the threshold cover (100) by an installer to further attach the threshold cover (100) on top of the existing threshold (108).

6. The method of claim 1, wherein the threshold cover (100) is notched to fit between the shortest dimension between the jambs (202) exposing portions of the existing door threshold (108).

7. The method of claim 5, wherein the screws are panhead screws or flat head screws.

8. A threshold cover (100), comprising:
a substantially flat horizontal portion (101) with a top non-skid surface (102), a bottom surface (103), a front edge (104), and a rear edge (105); and
a vertical portion (106) extending downward from the front edge (104) of the flat horizontal portion (101) and comprising a height sufficient to cover a front edge (107) of an existing threshold (108).

9. The threshold cover (100) of claim 8, wherein the flat horizontal portion (101) comprises a plurality of ridges (101a) extending along the length of the flat horizontal portion (101) to provide the top non-skid surface.

10. The threshold cover (100) of claim 8, wherein the vertical portion (106) is at least oriented substantially perpendicular or at a predefined angle to the flat horizontal portion (101), or curved outward to the flat horizontal portion (101).

11. The threshold cover (100) of claim 10, wherein the curved vertical portion (106) forms a longitudinally extending space with the front edge (104) of the flat horizontal portion (101).

12. The threshold cover (100) of claim 8, wherein the bottom surface (103) is substantially flat to provide surface-to-surface contact with the existing threshold (108).

13. A system for repairing an existing door threshold (108), comprising:
a cutting tool to cut a threshold cover (100) to match a measured length and width of the existing door threshold (108);
a multitool for notching at least two side jambs of a door to form two side notched openings (203) to allow the threshold cover (100) to slide over smoothly, or the threshold cover (100) around the two side jambs (202);
a rubber mallet for tapping and inserting the threshold cover (100) into the two side notched openings (203), or for snugly fitting the notched threshold cover (100) on top of the existing door threshold (108); and
wherein the threshold cover (100) comprising a substantially flat horizontal portion (101) with a top non-skid surface (102), a bottom surface (103), a front edge (104), and a rear edge (105); and a vertical portion (106) extending downward from the front edge (104) of the flat horizontal portion (101) and comprising a height sufficient to cover a front edge (107) of an existing threshold (108).

14. The system of claim 13, wherein the cutting tool comprising a metal cutting circular saw.

15. The system of claim 13, wherein the flat horizontal portion (101) comprises a plurality of ridges (101a) extending along the length of the flat horizontal portion (101) to provide the top non-skid surface.

16. The system of claim 13, wherein the vertical portion (106) is at least oriented substantially perpendicular or at a predefined angle to the flat horizontal portion (101), or curved outward to the flat horizontal portion (101).

17. The system of claim 13, wherein the two side jambs are notched 1/16″ to ⅛″ above the existing threshold (108) forming the two side notched openings (203) to allow the threshold cover (100) to slide over smoothly.

18. The system of claim 13, wherein the threshold cover (100) is notched to fit between the shortest dimension between the two side jambs (202) exposing portions of the existing door threshold (108).

19. The system of claim 13, wherein the threshold cover (100) is further fastened on top of the existing threshold (108) using screws installed into a set of holes drilled on the threshold cover (100) by the installer.

20. The system of claim 19, wherein the screws are panhead screws or flat head screws.
